(19) United States
(12) Patent Application Publication
(10) Pub. No.: US 2011/0045225 A1
(43) Pub. Date: Feb. 24, 2011

(54) Flexible Dashboard Barrier

(76) Inventors: Ted Riser, Geneva, OH (US); Michael Giarrizzo, JR., Chagrin Falls, OH (US)

Correspondence Address: CURATOLO SIDOTI CO., LPA, 24500 CENTER RIDGE ROAD, SUITE 280, CLEVELAND, OH, 44145, US

(21) Appl. No.: 12/775,587

(22) Filed: May 7, 2010

Related U.S. Application Data
(60) Provisional application No. 61/176,543, filed on May 8, 2009.

(51) Int. Cl. B32B 1/00; B32B 3/26; B32B 3/00; B32B 33/00

(52) U.S. Cl. 428/41.7; 428/174; 428/156; 428/41.8; 428/100

(57) ABSTRACT

A dashboard barrier for attachment to the top surface of the dashboard of a vehicle, such as an automobile or boat. The dashboard barrier includes a unitary body including a base portion and at least one upstanding side wall portion. The dashboard barrier attaches to the top surface of the vehicle dashboard and is able to conform to the general shape of the dashboard. The forward-most portion of the dashboard barrier is attached to the top surface of the dashboard so that it contact inner surface of vehicle's windshield and extends to the edge of the dashboard. When mounted in proper position on the vehicle dashboard, the barrier lies generally perpendicular to the longitudinal axis of the dashboard, thus dividing the dashboard into two sections. The dashboard barrier prevents loose objects from shifting or sliding from one section of the dashboard to the other section of the dashboard while the vehicle is in motion.

### CROSS REFERENCE TO RELATED APPLICATIONS

This application claims the benefit of the filing date under 35 U.S.C. §119(e) from United States Provisional Application For Patent Ser. No. 61/176,543 filed May 8, 2009, which is hereby incorporated by reference in its entirety.

### TECHNICAL FIELD

The disclosed subject matter relates to a device that serves as a dashboard barrier for automobiles, boats and the like to prevent loose objects from shifting or sliding from one section of the dashboard to the other section of the dashboard during normal operation.

### BACKGROUND

Drivers of automobiles or boaters often need to store objects such as cell phones, media players, handheld computers, pens, pencils, important papers, calculators, turnpike tickets, sunglasses, cigarettes and coins in a convenient location. Often times, the driver places these items on the dashboard of the automobile or boat for easy retrieval.

Because these items remain loose on the top surface of the dashboard, they tend to slide about when the automobile or boat is brought to a sudden stop or turned sharply. This can lead to a dangerous injury hazard for the driver or other occupant when the loose items fly about the interior of the vehicle. Moreover, if the driver attempts to retrieve these items while driving, his/her attention must be diverted from the roadway, thereby increasing the potential for an accident.

Numerous attempts have been made to provide a location to store the various items that a driver may need to take in the vehicle. The original location familiar to all is the glove compartment or glove box. The problem with this location is that it is typically located on the passenger side of the vehicle, and is too far from the driver to be easily reached. Also, the glove box door opens downward and allows the items stored in the glove box to easily spill out.

Other attempts to provide a convenient location for storing items include a console between the driver's seat and the passenger seat. The typical console performs the dual functions of providing a convenient place to store items and as an arm rest for the driver. Since the console is top opening, it functions much better than the conventional glove box in holding these various objects. The console may also incorporate electrical outlets for portable electronic devices. Like the glove compartment, the center console is not positioned in an optimal position and the driver must turn sideways and look down to open the console and then look through the console to locate the item of interest.

Other attempts to store items include overhead storage compartments. Many drivers use these overhead compartments for storage of important papers or subglassess. However, the overhead compartments are generally limited in size and therefore cannot accommodate a wide variety of items that a driver may need to store in the vehicle. Furthermore, the driver must take his/her eyes away from the road to open the overhead compartment, which presents an accident hazard. Additionally, the overhead compartments open downward and items tend to fall out onto the lap of the driver or the floor of the vehicle. The driver would need two hands to open the overhead compartment and retrieve certain items, while preventing other items from spilling out. Items also sometimes inadvertently spill out of an overhead compartment, thereby startling the driver and potentially causing an accident.

### SUMMARY

Provided is a flexible dashboard barrier in combination with a dashboard of a vehicle, said dashboard barrier comprising a unitary body comprising a base portion and an integral wall portion extending upwardly from base portion.

### BRIEF DESCRIPTION OF THE DRAWINGS

FIG. 1 is an end view of one illustrative embodiment of the dashboard barrier.

FIG. 2 is an end view of the illustrative of FIG. 1 with a catch lip extending from the side wall.

FIG. 3 is an end view of the illustrative embodiment of FIG. 1 with the base portion having an inclined edge.

FIG. 4 is an end view of another illustrative embodiment of the dashboard barrier.

FIG. 5 is an end view of the illustrative of FIG. 4 with a catch lip extending from the side wall.

FIG. 6 is an end view of the illustrative embodiment of FIG. 4 with the base portion having an inclined edge.

FIG. 7 is a perspective view of the illustrative embodiment of FIG. 1 in combination with a vehicle dashboard.

### DETAILED DESCRIPTION

Disclosed is a dashboard barrier for mounting on the dashboard of a vehicle such as an automobile, van, truck, or boat. The dashboard barrier serves to prevent loose items that have been placed on the top surface of the dashboard from shifting or sliding from one section of the dashboard to the other section of the dashboard while the vehicle is in motion.

The dashboard barrier comprises a unitary body comprising a base portion and a side all portion extending upwardly from the base portion. The base portion of the dashboard barrier body attaches to the upper surface of the vehicle dashboard. Because the dashboard organizer may be manufactured from a flexible and pliable material, when properly placed, the base portion approximately conforms to the general shape of the upper surface of the dashboard. The flexibility of the barrier to conform to the dashboard surface is important as vehicle dashboards are provided with a wide variety of different surface contours. The side wall of the dashboard barrier extends upwardly from the upper surface of the base portion and is held in a substantially perpendicular position in relation to the base portion and dashboard surface. In certain embodiments, the forward-most portion of the dashboard barrier is arranged so that it comes into contact with the inner surface of the vehicle's windshield, and the remainder of the barrier extends away from the windshield along substantially the entire length of the short axis of the dashboard. When affixed in proper position on the vehicle dashboard, the barrier lies generally perpendicular to the long axis of the dashboard, thus dividing the dashboard into two sections.

According to certain embodiments, the dashboard barrier comprises a base portion and a side wall portion extending upwardly from base portion. A “catch” lip may be extending from one surface of the upwardly extending side wall may be provided. The “catch” lip may be provided near the top of the side wall. Alternatively, the “catch” lip may be provided at any height along the upwardly extending side wall. The lip extends substantially perpendicular to the side wall.

According to certain embodiments, the dashboard barrier comprises a base portion and a side wall portion extending upwardly from base portion. One edge of the base portion of the dashboard barrier may include an incline plane or ramp to permit loose items to easily pass up the plane on onto the upper surface of the base portion of the barrier. By providing the incline plane, loose items pass onto the base and are stopped from shifting to another part of the dashboard by the side wall.

According to certain embodiments, the dashboard barrier comprises a base portion and a side wall portion extending upwardly from base portion. According to these embodiments, the dashboard barrier may include the above-described “catch” lip and the incline plane. The “catch” lip may extend from one or both surfaces of the upwardly extending side wall. The “catch” lip may be provided near the top of the side wall. Alternatively, the “catch” lip may be provided at any height along the upwardly extending side wall.

The barrier maybe attached to the dashboard surface with adhesives or mechanical fasteners. An adhesive that is capable of adhering the lower surface of the dashboard barrier to the top surface of the vehicle dashboard may be used. Without limitation, suitable adhesives include pressure sensitive adhesives, epoxies, urethanes, acrylics, an adhesive tape such as a double sided adhesive tape, and room temperature vulcanizing (RTV) silicones.

According to other embodiments, the VELCRO™ hook and loop fasteners commercially available from the 3M Company (Minneapolis, Minn., USA) may be used to affix the dashboard barrier to the top surface of the vehicle dashboard. The use of VELCRO™ will render the dashboard barrier easily removable and therefore able it may be used in one or more different vehicles.

Flexible vehicle dashboards are provided in a wide variety of complex shapes consisting of undulating surfaces and compound curves. When the dashboard barrier is properly placed affixed on the top surface of the dashboard, the lower surface of the base portion of the barrier conforms to the geometry of the dashboard, thereby preventing any loose items from passing under the dashboard barrier and shifting to the another side of the dashboard. Furthermore, the ability to conform the pliable dashboard barrier to the profile of the windshield further enhances the utility of the barrier in preventing loss of articles stored on top of the dashboard.

Various illustrative embodiments of the dashboard barrier will now be described in greater detail with reference to the FIGURES. It should be noted that the dashboard barrier, dashboard barrier-dashboard combination and methods of use are not intended to be limited to the illustrative embodiments shown in the FIGURES.

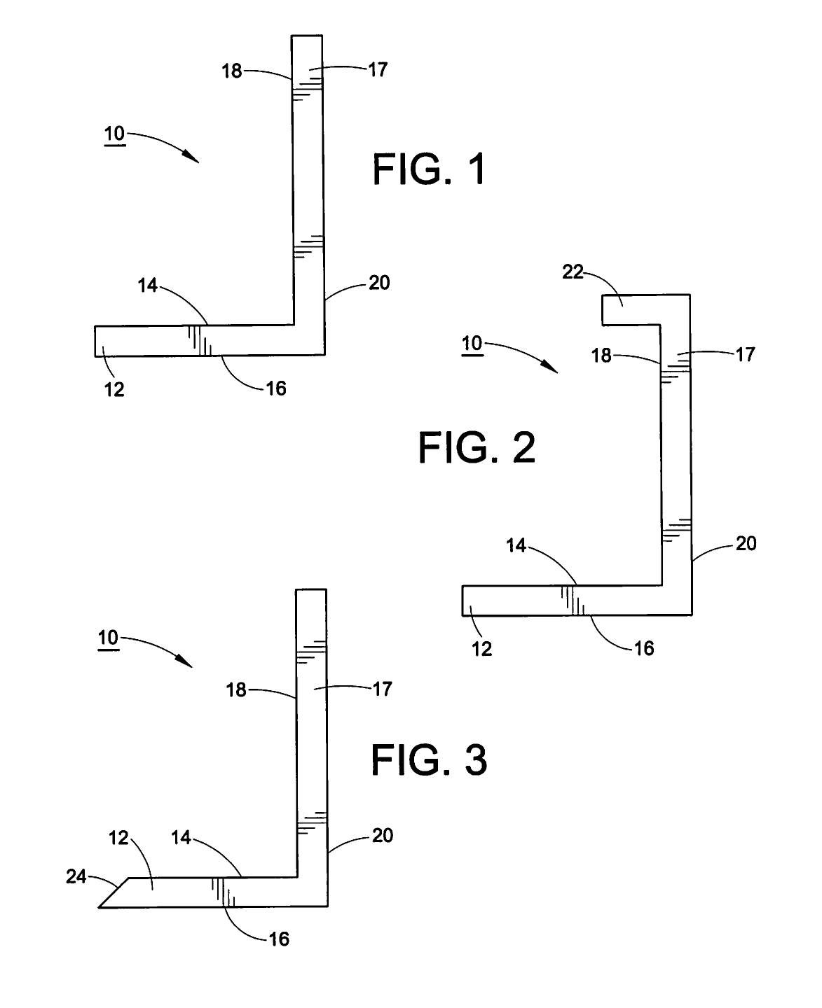

FIG. 1 shows one illustrative embodiment of the dashboard barrier 10. Dashboard barrier 10 comprises a continuous barrier comprising a base portion 12 having opposite facing upper 14 and lower 16 surfaces. Side wall 17 includes opposite facing first 18 and second 20 surfaces. Side wall 17 extends upwardly from the top surface 16 of base portion 12. According to FIG. 1, base portion 12 and side wall 17 are integral. By integral, it is meant that the base portion 12 and side portion 14 form a single continuous piece. As there is no gap or openings between the base 12 and side wall 17, there is no possibility for items to pass through the barrier 10.

FIG. 2 shows another illustrative embodiment of the dashboard barrier 10 including a catch lip. According to the embodiment shown in FIG. 2, dashboard barrier 10 comprises a continuous barrier comprising a base portion 12 having opposite facing upper 14 and lower 16 surfaces. Side wall 17 extends upwardly from the top surface 16 of base portion 12. Catch lip 22 extends outwardly from first surface 18 of side wall 17.

FIG. 3 shows another illustrative embodiment of the dashboard barrier 10. According to the embodiment shown in FIG. 3, dashboard barrier 10 comprises a continuous barrier comprising a base portion 12 having opposite facing upper 14 and lower 16 surfaces. Side wall 17 extends upwardly from the top surface 14 of base portion 12. Base portion 12 of dashboard barrier 10 includes incline plane 24 to permit loose objects to cross onto upper surface 16 of base portion 12.

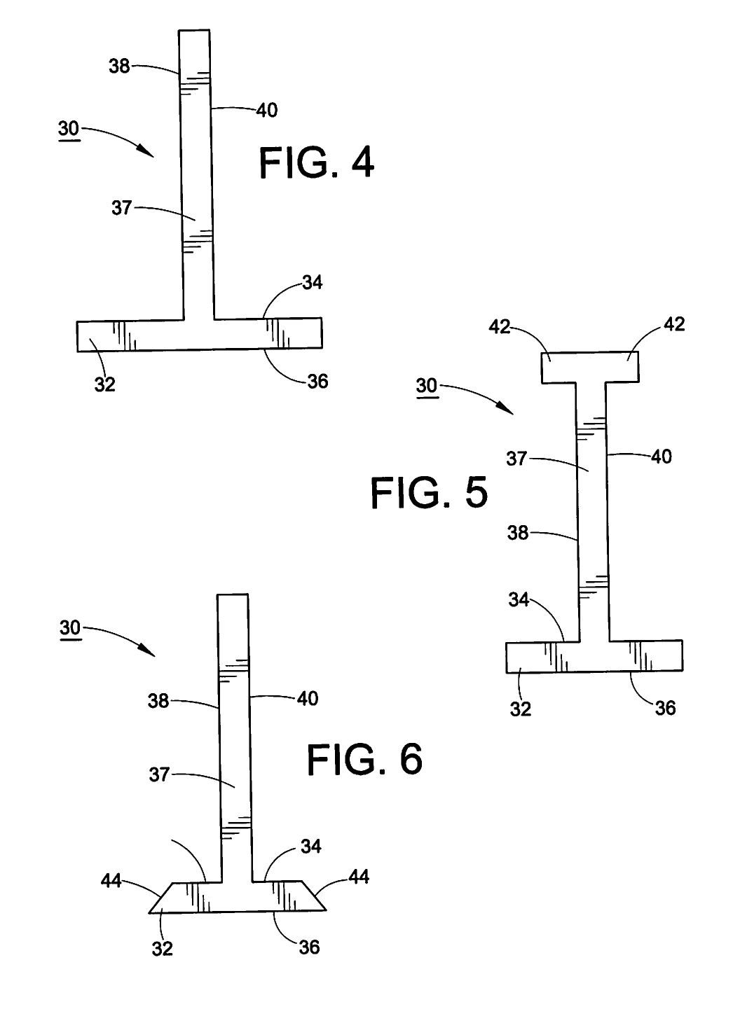

FIGS. 4-6 are directed flexible dashboard barriers that have a T-shape.

FIG. 4 shows one illustrative embodiment of the dashboard barrier 30. Dashboard barrier 30 comprises a continuous barrier comprising a base portion 32 having opposite facing upper 34 and lower 36 surfaces. Side wall 37 includes opposite facing first 38 and second 40 surfaces. Side wall 34 extends upwardly from the upper surface 36 of base portion 32.

FIG. 5 shows another illustrative embodiment of the dashboard barrier 30. According to the embodiment shown in FIG. 5, dashboard barrier 30 comprises a continuous barrier comprising a base portion 32 having opposite facing upper 34 and lower 36 surfaces. Side wall 37 extends upwardly from the upper surface 34 of base portion 32. Catch lip 42 extends outwardly from both first 38 and second 40 surfaces of side wall 37.

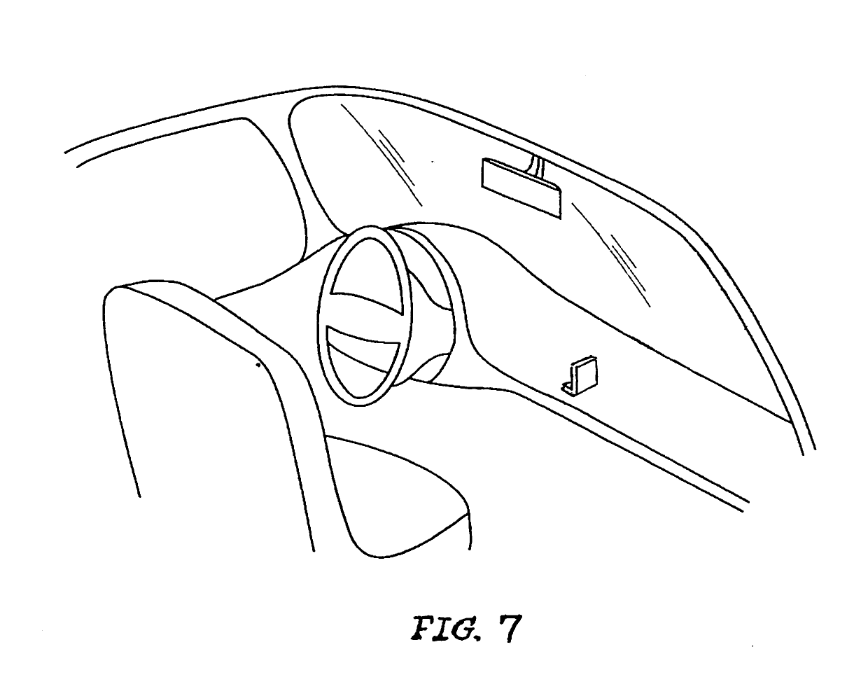

FIG. 6 shows another illustrative embodiment of the dashboard barrier 30. According to the embodiment shown in FIG. 6, dashboard barrier 30 comprises a continuous barrier comprising a base portion 32 having opposite facing upper 34 and lower 36 surfaces. Side wall 37 extends upwardly from the upper surface 36 of base portion 32. Base portion 32 of dashboard barrier 30 includes incline planes 44 to permit loose objects to cross onto upper surface 34 of base portion 32.

FIG. 7 shows the dashboard barrier of the illustrative embodiments of FIGS. 1-3. According to FIG. 7, flexible dashboard barrier 10 is shown in intimate contact with the top surface of the vehicle dashboard 50. Because of the flexible nature of dashboard barrier 10, it has been contact manipulated to remain in continuous contact with the undulating surface of the dashboard.

According to certain illustrative embodiments, the lower surface of base portion of dashboard barrier includes an adhesive layer for adhering dashboard barrier to the top surface of a dashboard. The adhesive layer may be deposited on the lower surface of the base portion as a continuous or discontinuous pattern. Adhesive layer may be protected from damage by a release paper coated with a release coating. A siliconized release paper is particularly useful in combination with protecting the adhesive layer of the dashboard barrier.

According to other illustrative embodiments, the flexible dashboard barrier includes VELCRO hook and loop fasteners for attaching dashboard barrier to the top surface of a dashboard. The hook and loop fastener generally includes two layers. One layer is generally referred to as the hook layer, while the second layer is generally referred to as the loop layer. The hook layer comprises a layer of fabric with a plurality of hooks protruding therefrom. The loop layer comprises a layer of fabric with a plurality of smaller, fuzzier, randomly-oriented protrusions. When the hook and loop layers are pressed together, the hooks catch or otherwise become entangled with the loops to secure to the two layers together. The one layer of the hook and loop fastener is adhered to the bottom surface of flexible dashboard barrier, while the second layer is adhered to the top surface of the vehicle dashboard. When the dashboard barrier is moved into close proximity to the top surface of the vehicle dashboard, the hook and loop layers are pressed together, thereby securing the flexible barrier to the top surface of the vehicle dashboard.

The flexible barrier may be constructed from any material that permits the base of the barrier to conform to the upper surface of the substrate to which it is attached, for example, to the upper surface of the dashboard of an automobile or boat. Without limitation, the flexible barrier may be manufactured from flexible rubber material or a polymeric foam material. According to certain embodiments, the polymeric foam material may be coated with a layer of rubber coating to protect the foam.

While the drawing FIGURES depict illustrative embodiments of the flexible barrier wherein the base and side wall together form a 90°, or substantially right angle, it should be noted that the base and side wall may be arranged at any angle so long as the resulting angle still enables the device to perform is barrier function.

According to additional embodiments, the flexible barrier may also include an integral or detachable arm, hinge or hold-down means to secure papers or other items to the flexible dashboard barrier.

According to further embodiments, a netting means may be engaged with the flexible barrier to secure items from undesired movement.

According to yet further embodiments, the flexible barrier may also include one or more slots or grooves that are formed in the thickness of wither the base, the side wall or both.

The barrier may be provided as a single unit. However, according to certain embodiments, an elongated piece of flexible material may be provided with one or more areas of perforations. The length of flexible material may be separated along the perforations into more than on flexible barriers.

The flexible barrier may be adhered or otherwise attached to a wide variety of substrates to prevent the movement of items from one location to another. For example, and without limitation, the barrier may be used in combination with a desks, tables and workstations used by artists, architects, engineers, draftspersons and students.

While the dashboard barrier and methods of use have been described in connection with various illustrative embodiments, it is to be understood that other similar embodiments may be used or modifications and additions may be made to the described embodiments for performing the same function disclosed herein without deviating therefrom. The embodiments described above are not necessarily in the alternative, as various embodiments may be combined to provide the desired characteristics. Therefore, the garment tag and methods should not be limited to any single embodiment, but rather construed in breadth and scope in accordance with the recitation of the appended claims.

1. A dashboard barrier in combination with a dashboard of a vehicle, said dashboard barrier comprising integral base and side wall portions wherein extending upwardly from base portion.

2. The combination of claim 1 wherein said side wall extends substantially perpendicularly from said base portion.

3. The combination of claim 2 wherein said barrier comprises a lip extending outwardly from said side wall.

4. The combination of claim 3 wherein said lip extends substantially perpendicularly from said side wall.

5. The combination of claim 2 wherein said base portion comprises an incline plane.

6. The combination of claim 3 wherein said base portion comprises an incline plane.

7. The combination of claim 1 wherein said dashboard barrier is L-shaped.

8. The combination of claim 1 wherein said dashboard barrier is T-shaped.

9. The combination of claim 1 wherein said dashboard barrier is conformable to the upper surface of said vehicle dashboard.

10. The combination of claim 1 wherein said barrier is attached to said dashboard with an adhesive or a mechanical fastener.

11. The combination of claim 10 wherein a surface of the base portion of said dashboard barrier includes an adhesive layer.

12. The combination of claim 11 further comprising a protective layer covering said adhesive layer.

13. The combination of claim 12 wherein said protective layer comprises a release paper having a release coating thereon.

14. The combination of claim 13 wherein said release coating comprises a silicone release coating.

15. The combination of claim 10 wherein said mechanical fastener comprises a hook-and-loop fastener.

16. The combination of claim 1 wherein said barrier comprises a detachable arm, hinge or hold-down means to secure items.

17. The combination of claim 1 further comprising a netting means engaged with a portion of said barrier.

18. The combination of claim 1 wherein said barrier include one or more slots or grooves within the thickness of the base portion or said wall.

19. The combination of claim 1 wherein one end of said barrier is in contact with the inner surface of the vehicle's windshield.

20. The combination of claim 19 wherein said barrier extends substantially perpendicular to the long axis of the vehicle dashboard.
